(19) United States
(12) Patent Application Publication
(10) Pub. No.: US 2026/0360989 A1
(43) Pub. Date: Nov. 12, 2026

(54) ASYMMETRIC RADAR LENS

(71) Applicant: Banner Engineering Corp., Minneapolis, MN (US)

(72) Inventors: Jamie Rhead, Minneapolis, MN (US); Chunmei Kang, Minneapolis, MN (US); Chris Ladas, Minneapolis, MN (US)

(73) Assignee: Banner Engineering Corp., Minneapolis, MN (US)

(21) Appl. No.: 19/470,334

(22) PCT Filed: Mar. 31, 2023
(86) PCT No.: PCT/US2023/065228

§ 371 Date: Sep. 29, 2025

(51) Int. Cl. H01Q 15/08; H01Q 19/06

(52) U.S. Cl. CPC H01Q 15/08; H01Q 19/062

(57) ABSTRACT

Apparatus and associated methods relate to an object detection system using an asymmetric radar beam emission system (ARBES) to achieve a target two dimensional field-of-view (2DFOV). In an illustrative example, the ARBES, for example, may include a lens module configured to receive a radar beam at an internal surface. The lens module may, for example, also include an external service configured to emit a shaped radar beam. For example, the internal surface may include a first radius of curvature in an x-direction and a second radius of curvature in a y-direction, and the external surface may include a third radius of curvature in the x-direction and a fourth radius of curvature in the y-direction. The four radii of curvatures may be independently configurable. Various embodiments may advantageously shape the radar beam in four degrees of freedom to adjust the 2DFOV of the ARBES.

### CROSS-REFERENCE TO RELATED APPLICATIONS

The subject matter of this application may have common inventorship with and/or may be related to the subject matter of the following:
U.S. application Ser. No. 17/036,255, titled “Near Range Radar,” filed by Ashley Wise, et al., on Sep. 29, 2020.
U.S. application Ser. No. 17/823,361, titled “Self-Contained Range Detection Systems with Reconfigurable Chatter-Mitigated Output Indication,” filed by Chunmei Kang, et al., on Aug. 30, 2022.
U.S. Application Ser. No. PCT/US2022/075689, titled “Self-Contained Range Detection Systems with Reconfigurable Chatter-Mitigated Output Indication,” filed by Chunmei Kang, et al., on Aug. 30, 2022.
U.S. application Ser. No. 17/072,028, titled “Image-based Jam Detection,” filed by Wade Oberpriller, et al., on Oct. 15, 2020, issued as U.S. Pat. No. 11,251,328 on Dec. 6, 2022.
U.S. application Ser. No. 18/047,958, titled “Image-based Jam Detection,” filed by Wade Oberpriller, et al., on Oct. 19, 2021.
U.S. application Ser. No. 17/654,010, titled “Non-Contact Motion Detection Sensor Utilizing Distance and Intensity Statistics,” filed by Wade Oberpriller, et al., on Mar. 8, 2022.
PCT. Application Serial No. PCT/US22/71937, titled “Non-Contact Motion Detection Sensor Utilizing Distance and Intensity Statistics,” filed by Wade Oberpriller, et al., on Mar. 8, 2022.
U.S. application Ser. No. 17/303,061, titled “Pixel Domain Field Calibration of Triangulation Sensors,” filed by Wade Oberpriller, on Mar. 8, 2022.
PCT Application Serial No. PCT/US22/71036, titled “Pixel Domain Field Calibration of Triangulation Sensors,” filed by Wade Oberpriller, on Mar. 8, 2022.

This application incorporates the entire contents of the foregoing application(s) herein by reference.

### TECHNICAL FIELD

Various embodiments relate generally to radar systems.

### BACKGROUND

Radar technology has been in use for over a century for detecting, locating, and tracking objects. For example, a radar system may use a fixed antenna configured to emit a continuous radar beam in a single direction. For example, the radar beam may propagate through the air in an inherent wavelength. For example, some radar beams may be reflected by objects in their path. The radar beams that are reflected back to the radar system may be analyzed to determine the location, velocity, and other characteristics of the objects.

In some examples, the radar systems may be configured to accurately detect and track objects in cluttered environments. For example, there may be multiple objects in close proximity to the radar system. For example, the radar beams may be affected by noise or interference. Some radar systems, for example, may include frequency agility, waveform diversity, and adaptive signal processing, and other techniques to minimize noise or interference.

In some examples, some radar systems may be optimized to detect or track objects in an application specific environment, for example, including short-range tracking applications, long-range detection applications, low-altitude detection applications, high-altitude detection applications, specific target detection applications, and/or moving targets detection applications. To configure the radar system for those applications, various types of radar systems may be used, such as a pulse radar, a continuous wave radar, a frequency-modulated continuous wave radar, and a synthetic aperture radar.

### SUMMARY

Apparatus and associated methods relate to an object detection system using an asymmetric radar beam emission system (ARBES) to achieve a target two dimensional field-of-view (2DFOV). In an illustrative example, the ARBES, for example, may include a lens module configured to receive a radar beam at an internal surface. The lens module may, for example, also include an external service configured to emit a shaped radar beam. For example, the internal surface may include a first radius of curvature in an x-direction and a second radius of curvature in a y-direction, and the external surface may include a third radius of curvature in the x-direction and a fourth radius of curvature in the y-direction. The four radii of curvatures may be independently configurable. Various embodiments may advantageously shape the radar beam in four degrees of freedom to adjust the 2DFOV of the ARBES.

Various embodiments may achieve one or more advantages. For example, some embodiments may include a single lens to advantageously simplify a design process. Some embodiments may, for example, include a housing configured to couple the lens module to a radar beam source at a predetermined distance from the internal surface to advantageously improve emission performance. For example, some embodiments may include a target thickness distribution profile of the lens module to advantageously model a desired intensity radar beam in the x-direction and the y-direction. Some embodiments may, for example, be configured to emit a wide angle radar beam in an orthogonal direction. For example, some embodiments may be configured to advantageously emit a super focused radar beam in an orthogonal direction. Some embodiments may, for example, include a coupling feature to advantageously couple the lens module to the housing. For example, some embodiments may advantageously be configured to adjust an intensity of the radar mean to traverse in cluttered environments.

The details of various embodiments are set forth in the accompanying drawings and the description below. Other features and advantages will be apparent from the description and drawings, and from the claims.

### BRIEF DESCRIPTION OF THE DRAWINGS

FIG. 1A and FIG. 1B depict an exemplary asymmetric radar beam emission system (ARBES) employed in an illustrative use-case scenario.

FIG. 2A and FIG. 2B depict an exemplary file of view and an exemplary intensity in a field of view as described with reference to FIG. 1A.

FIG. 3A and FIG. 3B show an exemplary beam shaping lens in orthogonal directions.

FIG. 4A, FIG. 4B, FIG. 4C, FIG. 4D, FIG. 4E, and FIG. 4F depicts a bottom perspective view, a top perspective view, a side view, a front view, a top view, and a bottom view, respectively of an exemplary beam shaping lens as described with respect to FIGS. 3A-B.

FIG. 5A and FIG. 5B show another embodiment of an exemplary beam shaping lens in orthogonal directions.

FIG. 6A, FIG. 6B, FIG. 6C, FIG. 6D, FIG. 6E, and FIG. 6F depicts a bottom perspective view, a top perspective view, a side view, a front view, a top view, and a bottom view, respectively of an exemplary beam shaping lens as described with respect to FIGS. 5A-B.

FIG. 7 is a flowchart illustrating an exemplary ARBES configuration method.

FIG. 8 is a flowchart illustrating an exemplary ARBES performance monitoring method.

Like reference symbols in the various drawings indicate like elements.

### DETAILED DESCRIPTION OF ILLUSTRATIVE EMBODIMENTS

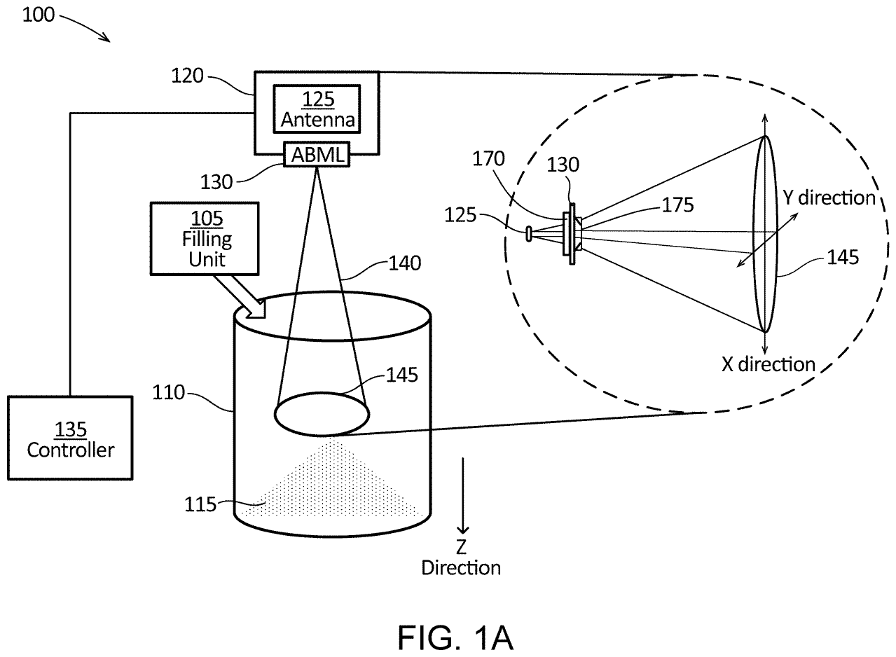

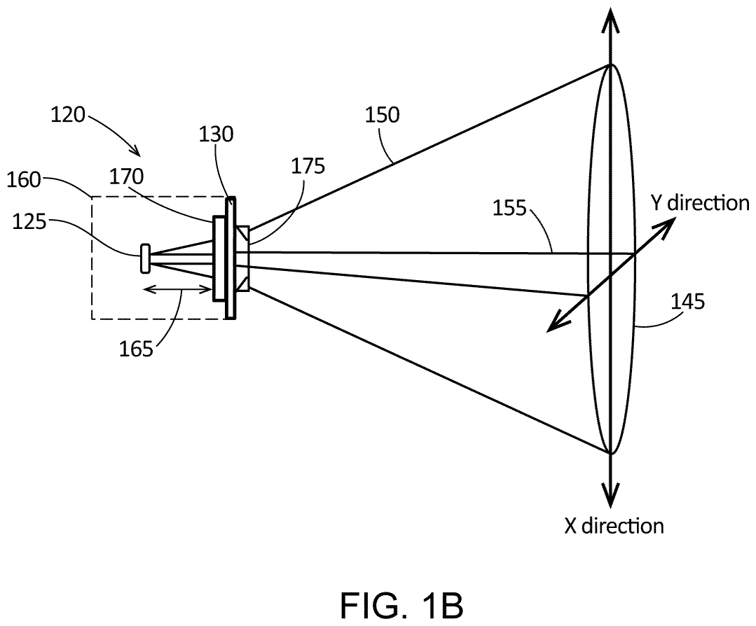

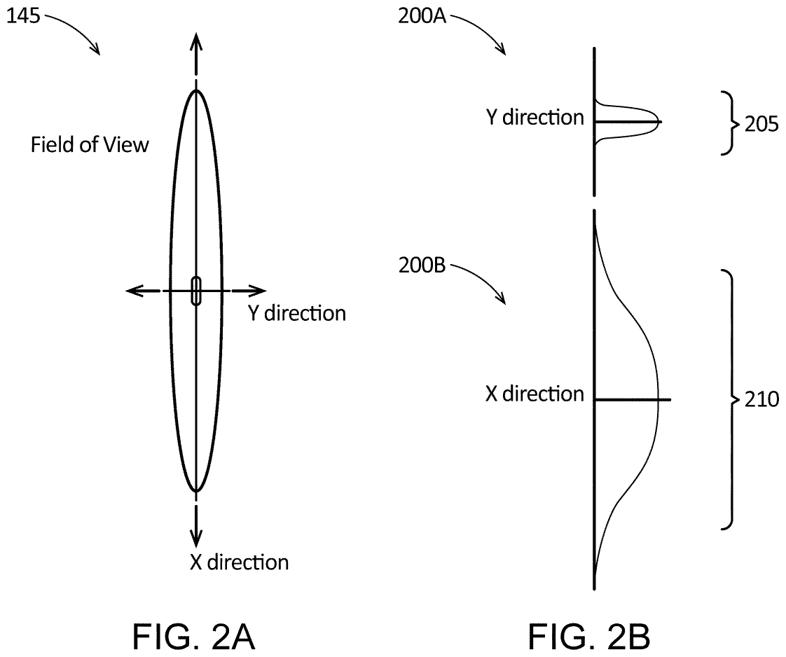

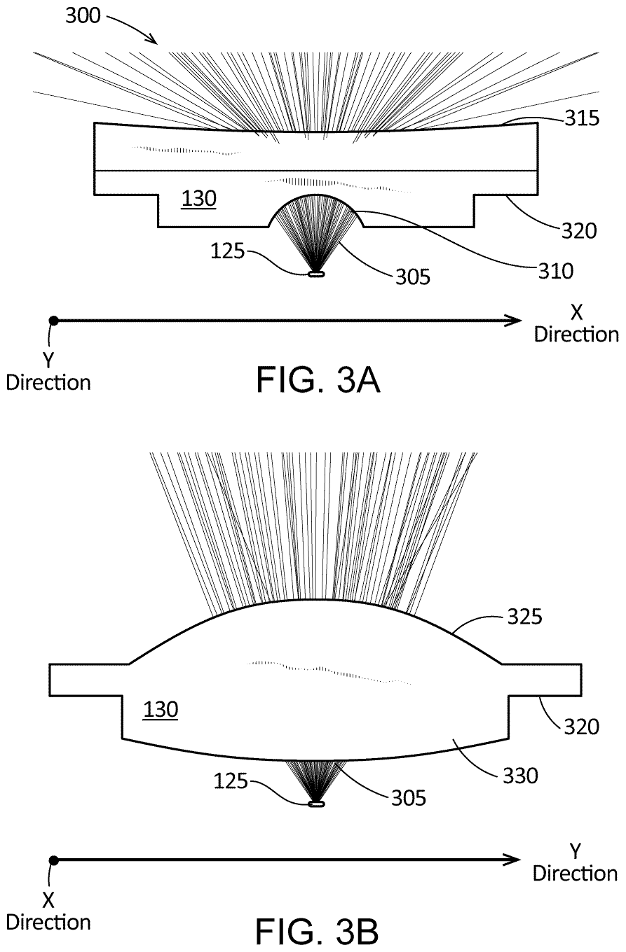

To aid understanding, this document is organized as follows. First, to help introduce discussion of various embodiments, an asymmetric radar beam emission system (ARBES) is introduced with reference to FIGS. 1A-2B. Second, that introduction leads into a description with reference to FIGS. 3A-6F of some exemplary embodiments of exemplary beam shaping lens. Third, with reference to FIGS. 7-8, exemplary methods for configuring and using the beam shaping lens are described. Finally, the document discusses further embodiments, exemplary applications and aspects relating to asymmetric radar beam shaping lens.

FIG. 1A and FIG. 1B depict an exemplary asymmetric radar beam emission system (ARBES) employed in an illustrative use-case scenario. As shown in FIG. 1A, a fill level detection system (FLDS 100) includes a filling unit 105 and a bin 110. For example, the FLDS 100 may be configured to generate a signal when the bin 110 is above a predetermined threshold level.

As shown, the filling unit 105 is filling objects 115 (e.g., bulk object, fluid, packages) into the bin 110. When the bin 110 is being filled, for example, a fill level of the objects 115 increases. In this example, the FLDS 100 includes an ARBES 120 to measure the fill level in the bin 110. Using radar technology, for example, the FLDS 100 may detect a distance between the ARBES 120 and one or more points (e.g., an area) of interest in the bin 110.

The ARBES 120 includes an antenna 125, and an asymmetric beam modification lens (ABML 130). For example, the antenna 125 emit a radar beam toward the filling objects 115. When the radar beam contacts a top surface of the filling objects 115, the radar beam may be reflected to a receiver of the antenna 125. In some implementations, the ARBES 120 may use the reflected radar beam to determine the fill level. Based on the fill level, for example, the ARBES 120 may transmit a measurement signal to a controller 135. For example, the measurement signal may be transmitted to the controller 135 via a network. For example, the measurement signal may be transmitted to the controller 135 via a point-to-point network communications standard and protocol (e.g., in the IEC 61131-9 standard, using IO-Link). The controller 135, for example, may control the FLDS 100 based on the measurement signal. For example, the controller 135 may reduce a rate of output of the filling unit 105 based on a measured fill level. For example, the controller 135 may generate a notification signal to remove the bin 110 because it is full.

The antenna 125, for example, may be small. In some implementations, the antenna 125 may be integrated on an integrated circuit (IC) chip. For example, the IC chip of the antenna 125 may include both an emitter and a receiver of the radar beam. In some examples, the antenna 125 may be a point source of the radar beam.

In some implementations, the antenna 125 may include off-the-shelf components. For example, the antenna 125 may include an original equipment manufacturer (OEM) antenna component. For example, the antenna 125 may emit the radar beam with a standardized viewing angle (e.g., 45°, 60°, 70°). In some examples, the antenna 125 may emit the radar beam in symmetric field of view angles (e.g., 60°×60°).

In some implementations, the ABML 130 may include a single lens. In some implementations, the ABML 130 may include two lenses. In some implementations, the ABML 130 may include multiple lenses. For example, the lens may be made of polycarbonate. For example, the lens may be made of propylene. For example, the lens may be made of plastic (e.g., Polyvinyl chloride (PVC), Acrylonitrile butadiene styrene (ABS), Zeonex polymer, acrylic). In some examples, the lens may be optically opaque.

The ABML 130, in this example, receives the radar beam emitted from the antenna 125 at an internal surface 170. At an external surface 175, for example, the ABML 130 may transmit the radar beam towards a target (e.g., the bin 110). In some implementations, the ABML 130 may independently modify the radar beam in orthogonal directions. For example, in an x-direction, the ABML 130 may widen the radar beam. For example, in the y-direction, the ABML 130 may narrow the radar beam. Accordingly, for example, the ABML 130 may modify an originally symmetric radar beam into a predetermined asymmetric radar beam for measurement.

As shown, the ARBES 120 may generate the radar beam to have a cone of detection (COD 140). For example, the COD 140 may include a shape of a cone extending outward from the ABML 130. In some examples, the COD 140 may include a 2-dimensional field-of-view (FOV 145) at a distance from the ARBES 120. In some implementations, the FOV 145 may be determined by independent curvatures of the internal surface 170 and external surface 175 of the ABML 130. For example, the FOV 145 may differ between the two orthogonal planes (e.g., x-plane and γ-plane) extending from the antenna 125. Various embodiments of the curvatures of the internal surface and external surface of the ABML 130 are described with reference to FIGS. 3A-6F.

As an illustrative example without limitation, the FLDS 100 may be configured to sense a three-dimensional volume in the bin 110 by a traversing radar beam. However, for example, an operation of the filling unit 105 may generate an obstructing dust that may prevent an accurate measurement of the fill level. For example, the ABML 130 may be configured to have curvatures to have a super focus FOV 145. For example, the super focus FOV 145 may penetrate through a cluttered environment to advantageously measure the fill level accurately. For example, the FOV 145 may be 10°×10°.

In some implementations, the ABML 130 may be replaceable to accommodate various applications (e.g., automotive blind-spot sensing applications, factory/industrial applications, aeronautic applications, car wash). For example, the FOV 145 of some applications may be asymmetric (e.g., 10°×60°, 10°×85°). For example, the resulting shaped beam may be a line beam. For example, the resulting shaped beam may be a spot beam. In some examples, the FOV 145 may be required to be wide (e.g., 10°×80°, 20°×70°). In some examples, the ARBES 120 may advantageously shape the radar beam into a desired FOV using standardized antenna 125.

As shown in FIG. 1B, the ARBES 120 may modify the FOV 145 independently in a x-direction and a y-direction. As shown, an x-axis view angle 150 may differ from a y-axis view angle 155. In this example, a radar beam is emitted by the antenna 125 through the ABML 130. The antenna 125 and the ABML 130 are enclosed by a housing 160 in this example. For example, the housing 160 may be a casing enclosing an IC chip of the antenna 125 and the ABML 130.

In some implementations, the internal surface 170 of the ABML 130 facing the antenna 125 may be positioned by the housing 160 at a predetermined distance 165 from the antenna 125. For example, the predetermined distance 165 may be a multiple (e.g., 1, 2, 4, 8, 12) of a half wavelength of the radar beam in air.

In various embodiments, the ABML 130 may be designed to include curvatures to independently modify a radar beam generated by the antenna 125 into a radar beam with the x-axis view angle 150 and the y-axis view angle 155. For example, the curvatures may be determined based on the antenna 125, the predetermined distance 165, a desired range of the radar beam, and the desired FOV 145.

In some implementations, the ABML 130 may include variably designed curvatures at the internal surface 170 and the external surface 175. For example, the lens surfaces 170, 175 may differ between the two orthogonal dimensions (x-direction and γ-direction). In some implementations, along the orthogonal dimensions, the ABML 130 may include different radii. For example, in a first dimension, the ABML 130 may be convex. For example, in a second dimension, the ABML 130 may be concave. For example, both dimensions of the ABML 130 may be concave. For example, both dimensions of the ABML 130 may be convex. For example, the ABML 130 may include a single lens with, for each of the internal surface 170 and the external surface 175, different curvature of radii along two orthogonal axes. In some examples, the different curvature of radii may cause the COD 140 narrower along one direction and wider along the other. In some implementations, the 4 different curvature values may be modified as desired to widen or narrow the beam in the two orthogonal directions. For example, the FOV 145 may advantageously be configured as desired.

In some implementations, the orthogonal dimensions of the internal surface 170 and the external surface 175 may be parallel to each other. For example, axes of curvature variations of the internal surface and the external surface may be parallel. In some implementations, the axes of curvature on outside and inside (e.g., the orthogonal directions of the internal surface 170 and the orthogonal directions of the external surface 175) may be rotated relative to each other about an emission axis of the radar beam. For example, the shaped radar beam may advantageously be skewed.

In some implementations, one or both of the internal surface 170 and the external surface 175 may include more than two axes of curvature. For example, a surface of the ABML 130 may include three axes of curvature. For example, the ABML 130 may include five axes of curvature in the internal surface 170 and the external surface 175. For example, the ABML 130 may include six axes of curvature in the internal surface 170 and the external surface 175.

FIG. 2A and FIG. 2B depict an exemplary file of view and an exemplary intensity in a field of view as described with reference to FIG. 1A. As shown in FIG. 2A, the FOV 145 is narrow in the y-direction and wide in the x-direction. As an illustrative example shown in FIG. 2B, with a narrower FOV, the radar beam may include a higher intensity 205 in the y-direction as shown in a graph 200A. With a wider FOV, in the x-direction, the radar beam may include a lower intensity 210 direction as shown in a graph 200B, for example.

In some implementations, the ABML 130 may include a (three dimensional) thickness distribution profile defined by the radii of curvatures in the internal surface 170 and radii of curvatures in the external surface 175. For example, accordingly, the ARBES 120 may advantageously include a configurable focusing power in each of the orthogonal directions. In some implementations, when the ABML 130 is replaceable, the focusing power may advantageously be field adjustable.

In various implementations, a radar system (e.g., the ARBES 120) may include a radar antenna (e.g., the antenna 125) configured to emit a radar beam and a single lens (e.g., the ABML 130) configured to receive the radar beam at an internal surface and emit a shaped beam at an external surface. For example, the internal surface and the external surface may each includes two radii of curvatures at two orthogonal axes on the corresponding surface. For example, each radius of curvatures may include a convex curvature, a concave curvature, or a combination thereof. In some embodiments, the radar antenna may be fixedly coupled at a predetermined distance from the internal surface. For example, the predetermined distance may be multiple of a half wavelength of the radar beam, such that the radar beam is shaped in four degrees of freedom by the single lens.

FIG. 3A and FIG. 3B show an exemplary beam shaping lens in orthogonal directions. In this example, a side view 300 of the ABML 130 into a y-direction across a x-direction is shown in FIG. 3A. As shown, the ABML 130 is receiving radar beams 305 from the antenna 125. The ABML 130 includes a concave internal surface 310 along the x-direction to receive the radar beams 305. For example, the concave internal surface 310 may diverge the radar beams 305. The ABML 130 also includes a concave external surface 315. For example, the concave external surface 315 may further diverge the radar beams 305. In some implementations, curvature of radii of the concave internal surface 310 and the concave external surface 315 may be different.

The ABML 130 also includes a ledge 320. For example, the ledge 320 may be a mounting surface. For example, the ledge 320 may be used for mounting the ABML 130 to another surface. For example, the ABML 130 may be mounted using the ledge 320 to the housing 160.

Various embodiments of installing and calibrating a lens (e.g., the ABML 130) to the housing 160 are described with reference to U.S. patent application Ser. No. 17/447,905, titled “Lens Alignment System with Multiple Degrees of Freedom”, filed by Dan Frost et al., on Sep. 16, 2021. For example, in FIG. 1 and FIG. 2B of the foregoing application and in paragraphs [0023-27], [0041] and [0051], various embodiments of accommodating an engagement surface (e.g., the ledge 320) of a lens body (e.g., the ABML 130) and a receiving surface a housing (e.g., the housing 160) are described. This application incorporates the entire contents of the foregoing application(s) herein by reference.

As shown in FIG. 3B, a side view 301 of the ABML 130 into the x-direction across the y-direction is shown. In this example, the ABML 130 includes, along the x-direction, a convex external surface 325 (e.g., curving outward from the lens) and a convex internal surface. Accordingly, for example, a shape of the ABML 130 shown in FIGS. 3A-B causes the radar beams 305 to be focused along the y-direction (with the convex external surface 325) while the radar beams 305 is diverged along the X-direction. In various implementations, a focused beam in a direction may increase a power intensity of the radar beam to advantageously increase range and/or penetrating power in that direction.

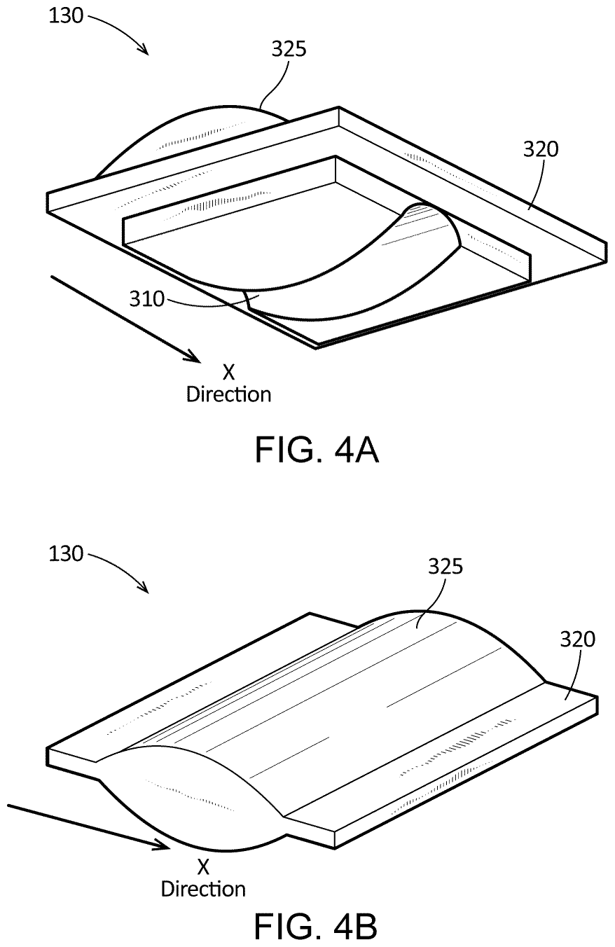

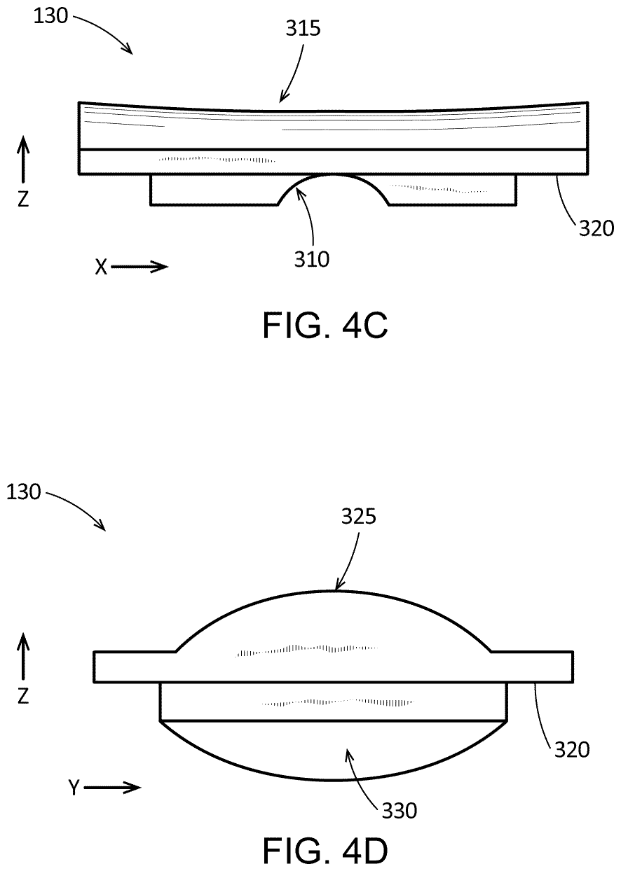

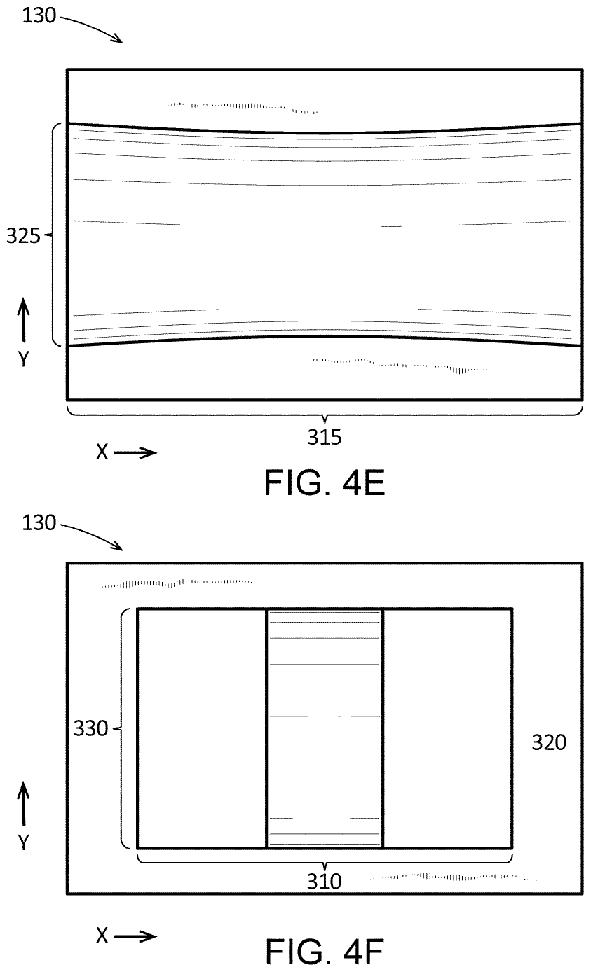

FIG. 4A, FIG. 4B, FIG. 4C, FIG. 4D, FIG. 4E, and FIG. 4F depicts a bottom perspective view, a top perspective view, a side view, a front view, a top view, and a bottom view, respectively of an exemplary beam shaping lens as described with respect to FIGS. 3A-B. As shown in FIG. 4A, the ABML 130 includes the concave internal surface 310 and the concave external surface 315 along the x-direction. In this example, the ABML 130 includes a ledge 320 around an edge to be mounted on another surface. In some implementations, the ledge 320 may be configured as other mounting features. For example, the ledge 320 may be disposed on only a portion of the perimeter of the ABML 130. For example, the ledge 320 may include one or more extended pins configured to engage a mating surface. In other examples, the ledge 320 may include a coupling groove configured to engage another mating feature. In FIG. 4B, the concave external surface 315 along the y-direction is shown.

In FIG. 4C, the concave internal surface 310 and the concave external surface 315 are shown to be a single structure along a z direction. In FIG. 4D, the convex external surface 325 and the convex internal surface 330 are shown to be a single structure along the z direction. In some implementations, the ledge 320 and the mounting surface of the housing 160 may be frictionally engaged. For example, the ABML 130 may adjust in the Z direction to accommodate variations (e.g., manufacturing variations) between the ledge 320 and a receiving surface of the housing 160. For example, the ABML 130 may translate up and down based on height variations. The ABML 130 may, in some implementations, rotate about an axis parallel to the X-direction by allowing the opposing sides (in the Y-direction) to independently move up and/or down in the Z direction to accommodate variations in flatness of the ledge 320 and/or the receiving surface. The rotation may, for example, be induced by interaction between the ledge 320 and the receiving surface inducing a moment about an axis of rotation above a (predetermined) minimum net moment. The (predetermined) minimum net moment may, for example, be determined by a (limited) frictional force between the ABML 130 and the housing 160.

In a top view shown in FIG. 4E, the concave external surface 315 and the convex external surface 325 are shown along the x-y plane. In a bottom view shown in FIG. 4F, the concave internal surface 310 and the convex internal surface 330 are shown along the x-y plane.

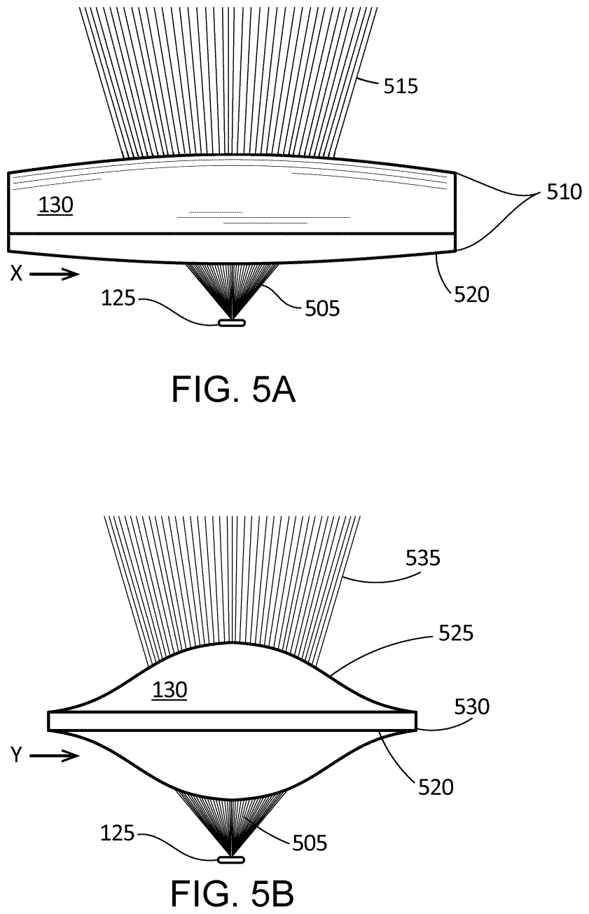

FIG. 5A and FIG. 5B show another embodiment of an exemplary beam shaping lens in orthogonal directions. In this example, as shown in FIG. 5A, the ABML 130 receives a radar beam 505. The ABML 130 includes convex internal and external surfaces 510 along the y-direction, orthogonal to the x-direction, to receive a radar beam emitted from the antenna 125. As a result, for example, a focusing beam 515 is transmitted from the ABML 130 that may include an un-modified FOV in the x-direction. The ABML 130 in this example also includes a ledge 520 for mounting the ABML 130 on another surface.

As shown in FIG. 5B, the ABML 130 includes a convex external surface 525 and a convex internal surface 530 along the x-direction, orthogonal to the y-direction. For example, the ABML 130 with a shape shown in FIGS. 5A-B may cause the radar beam 505 to be focused along the y-direction (as shown as a converged beam 535) while remaining unchanged along the x-direction (as shown by the unmodified beam 515).

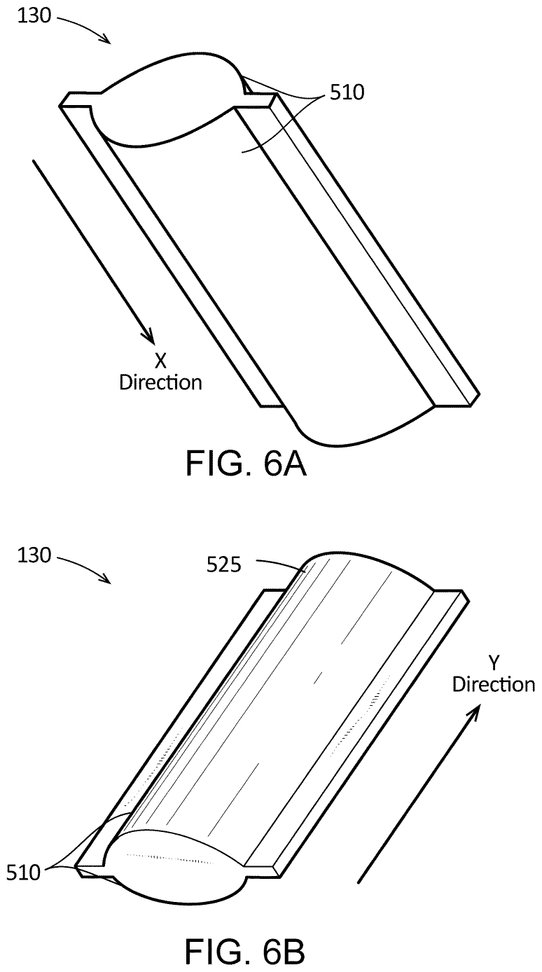

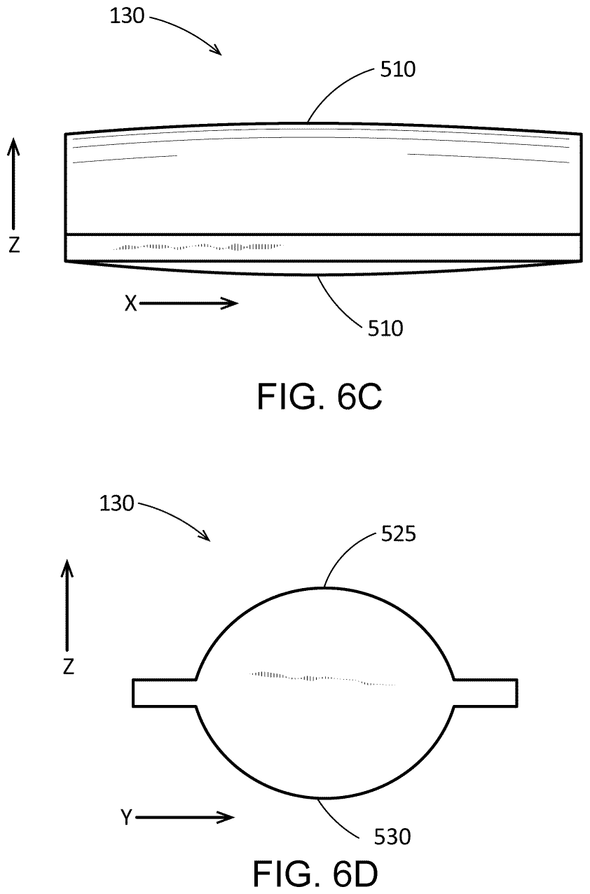

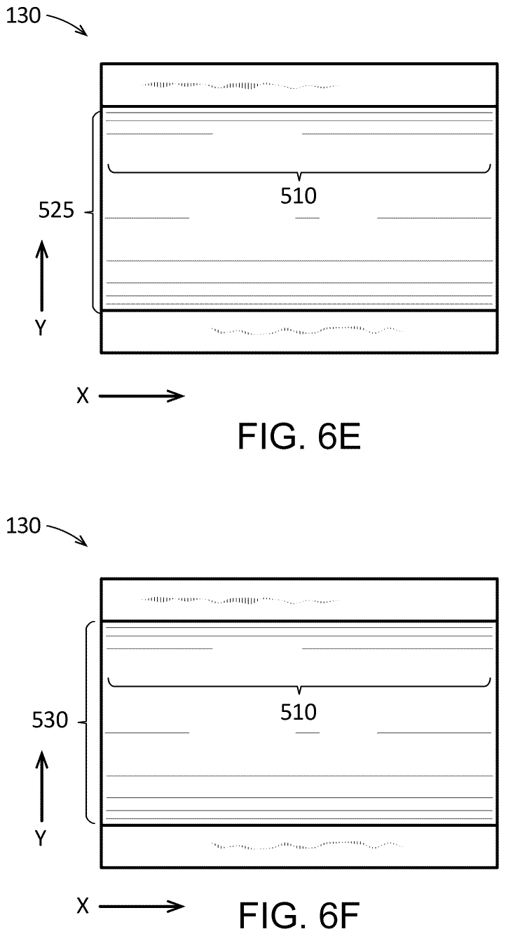

FIG. 6A, FIG. 6B, FIG. 6C, FIG. 6D, FIG. 6E, and FIG. 6F depicts a bottom perspective view, a top perspective view, a side view, a front view, a top view, and a bottom view, respectively of an exemplary beam shaping lens as described with respect to FIGS. 5A-B. As shown in FIG. 6A, the ABML 130 includes the convex internal and external surfaces 510 and the convex internal surface 530 in the x and γ-directions of the internal surface. In FIG. 6B, the convex internal and external surfaces 510 and the convex external surface 525 in the x and γ-directions of the external surface is shown. In FIG. 6C, the convex internal and external surfaces 510 are shown to be a single structure along a z direction. In FIG. 6D, the convex external surface 525 and the convex internal and external surfaces 510 are shown to be a single structure along the z direction. In a top view shown in FIG. 6E, the convex external surface 525 and the convex internal and external surfaces 510 are shown along the x-y plane. In a bottom view shown in FIG. 6F, the convex internal surface 530 and the convex internal and external surfaces 510 are shown along the x-y plane.

FIG. 7 is a flowchart illustrating an exemplary ARBES configuration method 700. For example, the exemplary ARBES configuration method 700 may be performed by an engineer using a computer device. In some implementations, some or all steps of the method may be automatically performed. In this example, the method 700 begins when a specification of an input radar beam is received in step 705. For example, the input radar beam may be retrieved from a characteristic profile of the antenna 125. For example, the antenna 125 may be an OEM equipment generating a radar beam having a symmetric FOV. For example, the characteristic profile may include the emission power of the radar beam. For example, the characteristic profile may include a specification of a COD of the radar beam.

Next, in step 710, a refraction profile of a lens is received. For example, the refraction profile may be generated based on a type of material of the ABML 130. For example, the refraction profile may include a beginning curvature and an ending curvature in each orthogonal axis for the internal surface 170 and the external surface 175 of the ABML 130.

A target FOV vector, in step 715, is determined. For example, the target FOV may include a target COD (e.g., the COD 145) of the ARBES. For example, the target FOV may include a focus intensity profile. The focus intensity profile may, for example, include a three dimensional profile of radar beam intensity in the target COD. For example, the target FOV may be determined based on an application of the ARBES 120. For example, the target FOV may be required to be super focused when a detection environment is determined to be noisy (e.g., within a car wash machine) and/or a detection area is required to be relatively small.

Next, in step 720, a spacing from an internal surface of the lens to a radar beam source (e.g., the antenna 125) may be determined. In some implementations, the spacing may be determined by design limitations and performance considerations. For example, it may be advantageous in performance if the spacing is a multiple of the half wavelength of the radar beam generated by the source. For example, the spacing may be limited by a size of the housing 160.

Based on the target FOV, the specification, the refraction profile, and the spacing, a first and a second radii of curvature of the internal surface and an external surface, respectively along a x-direction in step 725. Next, in step 730, a third and a fourth radii of curvature of the internal surface and an external surface, respectively, along a y-direction based on the target FOV, the specification, the refraction profile, and the spacing. The curvature radii may be generated as a predictive function of various input factors.

A thickness distribution profile of the lens is generated based on the first, the second, the third, and the fourth radii of curvature in step 735. For example, a focusing power (or diverging power) of the lens with respect to a view angle along a direction may increase as a function of a rate of change of a thickness of the lens in that direction. For example, a convex lens with equal thickness may have less focusing power compared to a convex lens with varying thickness. In some examples, the method 700 may determine the first, the second, the third, and the fourth radii of curvature based on a target focusing power (e.g., for getting super focused radar beam, very wide radar beam, a radar beam to longer distance, a radar beam to penetrate through obstacles).

In step 740, the resulting lens is tested. For example, a resulting beam may be predicted based on the starting beam shape and position modified by various radii of curvature of the internal surface 170 and the external surface 175 of a resulting lens (e.g., the ABML 130). In some implementations, performance of the ABML 130 may be modeled and/or simulated by an optical design tool (e.g., the OPTICALSTUDIO of ZEMAX headquartered in Kirkland, Washington). In some implementations, the resulting lens may be tested with a random damping box with a fixed known target. In a decision point 745, the test result is compared to a predetermined error threshold. If the test result is not within the predetermined error threshold, the step 725 is repeated. If the test result is within the predetermined error threshold, the exemplary ARBES configuration method 700 ends.

In some implementations, in the step 725 and the step 730, the x-direction and the y-direction of the internal surface 170 and the external surface 175 may be parallel to each other. In some implementations, the x-direction and the y-direction of the internal surface 170, and the x-direction and the y-direction of the external surface 175 may be rotated with respect to a z direction (e.g., the emission axis of the antenna 125) . . . . In some implementations, a plane defined by the x-direction and the y-direction of the internal surface 170, and a plane defined by the x-direction and the y-direction of the external surface 175 may be non-parallel to each other. Accordingly, the engineer may, for example, advantageously utilize at least four degrees of freedom (e.g., at least four axes of curvature, such as at least two on an internal surface and at least two on an external surface) in shaping the radar beam emitted by the antenna. For example, the engineer may also use at least four degrees of freedom to design a focus level to achieve the target focus intensity profile.

In various implementations, a method for designing a radar to have a predetermined FOV may include providing a single lens (e.g., the ABML 130) configured to receive a radar beam at an internal surface and emit a shaped beam at an external surface (e.g., the external surface 175), and determining a spacing from the internal surface (e.g., the internal surface 170) to the radar source. For example, the spacing may be a multiple of a half wavelength of the radar beam. For each of the internal surface 170 and the external surface 175, for example, curvatures of the lens surfaces may differ between the two orthogonal orientations as a function of the predetermined field-of-view of the emitted radar beam and the determined distance. For example, the radar beam may advantageously be shaped in four degrees of freedom by the single lens to match the predetermined field-of-view.

FIG. 8 is a flowchart illustrating an exemplary ARBES performance monitoring method 800. For example, the controller 135 of the FLDS 100 in FIG. 1 may include a performance monitoring engine to perform the ARBES performance monitoring method 800. In this example, the method 800 begins in step 805 when a performance test was run on an ARBES (e.g., the ARBES 120). For example, the performance monitoring engine may evaluate a measurement accuracy of the ABML 130. Next, in a decision point 810, it is determined whether the result is acceptable. For example, the controller 135 may include a set of testing criterion to determine whether a result is acceptable. If the result is acceptable, the method 800 ends.

If the result is not acceptable, in step 815, a replacement lens is determined based on a target FOV, a specification of an antenna of the ARBES, a refraction profile of the lens, and a spacing between the lens and the antenna. For example, the controller 135 may retrieve the target FOV, the specification of the antenna 125, the refraction profile of a list of available replacement ABMLs, and the spacing between the ABML 130 and the antenna 125 from a data store. After the replacement lens is determined, in step 820, a signal is transmitted to request the replacement lens, and the decision point 810 is repeated. For example, the housing 160 may be releasably coupled to the ABML 130 to advantageously facilitate replacement of the ABML 130. For example, the controller 135 may transmit a signal to a maintenance engineer to retrieve and replace the ABML 130 with the determined replacement lens.

In various implementations, different combinations of the curvatures in the ABML 130 may be available. As an illustrative example without limitation, the internal surface 170 may include curvatures in a first direction and a second direction, and the external surface 175 include curvatures in a third direction and a fourth direction. In some examples, some or all of the following combination of curvatures presented in Table 1 may be used in the ABML 130. Table is illustrative, by way of example and not limitation, and other combinations may be used in some implementations. For example, in some implementations, the first and second directions may relate to an interior lens surface and the third and fourth directions may relate to an exterior lens surface. In some implementations, three or more directions may relate to a single lens surface.

TABLE 1
Illustrative Combinations of Curvature

| First direction | Second direction | Third direction | Fourth direction |
|---|---|---|---|
| Convex | Convex | Convex | Convex |
| Convex | Convex | Convex | Concave |
| Convex | Convex | Concave | Convex |
| Convex | Convex | Concave | Concave |
| Convex | Concave | Convex | Convex |
| Convex | Concave | Convex | Concave |
| Convex | Concave | Concave | Convex |
| Convex | Concave | Concave | Concave |
| Concave | Convex | Convex | Convex |
| Concave | Convex | Convex | Concave |
| Concave | Convex | Concave | Convex |
| Concave | Convex | Concave | Concave |
| Concave | Concave | Convex | Convex |
| Concave | Concave | Convex | Concave |
| Concave | Concave | Concave | Convex |
| Concave | Concave | Concave | Concave |

Although various embodiments have been described with reference to the figures, other embodiments are possible. In some implementations, the ARBES 120 may include a pair of bistatic antennas. For example, the antenna 125 may include an emitter and a receiver on separate boards. For example, the ARBES 120 may include an emitter lens and a receiver lens. For example, one or both of the emitter lens and/or the receiver lens may include radii of curvatures for modifying the FOV. For example, the bistatic ARBES may include eight variables in radii of curvatures to modify the two-dimensional FOV.

In some embodiments, the ABML 130 may include a predetermined thickness distribution profile having radius of curvatures that may be aspheric. For example, the predetermined thickness distribution profile may define the internal surface 170 and/or the external surface 175 to be a conic modifier. For example, the predetermined thickness distribution profile may define the internal surface 170 and/or the external surface 175 by at least one polynomial modifier. For example, the predetermined thickness distribution profile may define the ABML 130 to have at least one conic modifier surface and/or at least one polynomial modifier surface.

In some implementations, a radius of curvature may include a skewed curvature along a direction on a surface. For example, a radius of curvature of the internal surface 170 in the x-direction may start to be convex in a distal end of the antenna 125. Towards a proximal end in the x-direction, the radius of curvature may become concave. Accordingly, the resulting FOV 145 may be asymmetric (e.g., skewed) along one or more of orthogonal directions of the FOV 145. For example, a skewed curvature lens may be structurally skewed (e.g., tensioned, bent, gel-filled). In some implementations, the skewed curvature lens may be actively varying to advantageously dynamically refocus (e.g., based on signal received from the controller 135).

Although an exemplary system has been described with reference to FIG. 1A, other implementations may be deployed in other industrial, scientific, medical, commercial, and/or residential applications.

In various embodiments, some bypass circuits implementations may be controlled in response to signals from analog or digital components, which may be discrete, integrated, or a combination of each. Some embodiments may include programmed, programmable devices, or some combination thereof (e.g., PLAs, PLDs, ASICs, microcontroller, microprocessor), and may include one or more data stores (e.g., cell, register, block, page) that provide single or multi-level digital data storage capability, and which may be volatile, non-volatile, or some combination thereof. Some control functions may be implemented in hardware, software, firmware, or a combination of any of them.

Computer program products may contain a set of instructions that, when executed by a processor device, cause the processor to perform prescribed functions. These functions may be performed in conjunction with controlled devices in operable communication with the processor. Computer program products, which may include software, may be stored in a data store tangibly embedded on a storage medium, such as an electronic, magnetic, or rotating storage device, and may be fixed or removable (e.g., hard disk, floppy disk, thumb drive, CD, DVD).

Temporary auxiliary energy inputs may be received, for example, from chargeable or single use batteries, which may enable use in portable or remote applications. Some embodiments may operate with other DC voltage sources, such as a 9V (nominal) batteries, for example. Alternating current (AC) inputs, which may be provided, for example from a 50/60 Hz power port, or from a portable electric generator, may be received via a rectifier and appropriate scaling. Provision for AC (e.g., sine wave, square wave, triangular wave) inputs may include a line frequency transformer to provide voltage step-up, voltage step-down, and/or isolation.

Although particular features of an architecture have been described, other features may be incorporated to improve performance. Other hardware and software may be provided to perform operations, such as network or other communications using one or more protocols, wireless (e.g., infrared) communications, stored operational energy and power supplies (e.g., batteries), switching and/or linear power supply circuits, software maintenance (e.g., self-test, upgrades), and the like. One or more communication interfaces may be provided in support of data storage and related operations.

Some systems may be implemented as a computer system that can be used with various implementations. For example, various implementations may include digital circuitry, analog circuitry, computer hardware, firmware, software, or combinations thereof. Apparatus can be implemented in a computer program product tangibly embodied in an information carrier, e.g., in a machine-readable storage device, for execution by a programmable processor; and methods can be performed by a programmable processor executing a program of instructions to perform functions of various embodiments by operating on input data and generating an output.

Various embodiments can be implemented advantageously in one or more computer programs that are executable on a programmable system including at least one programmable processor coupled to receive data and instructions from, and to transmit data and instructions to, a data storage system, at least one input device, and/or at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, which may include a single processor or one of multiple processors of any kind of computer. Generally, a processor will receive instructions and data from a read-only memory or a random-access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks, such as internal hard disks and removable disks; magneto-optical disks; and CD-ROM and DVD-ROM disks. The processor and the memory can be supplemented by, or incorporated in, ASICs (application-specific integrated circuits).

In some implementations, one or more user-interface features may be custom configured to perform specific functions. Various embodiments may be implemented in a computer system that includes a graphical user interface and/or an Internet browser. To provide for interaction with a user, some implementations may be implemented on a computer having a display device. The display device may, for example, include an LED (light-emitting diode) display. In some implementations, a display device may, for example, include a CRT (cathode ray tube). In some implementations, a display device may include, for example, an LCD (liquid crystal display). A display device (e.g., monitor) may, for example, be used for displaying information to the user. Some implementations may, for example, include a keyboard and/or pointing device (e.g., mouse, trackpad, trackball, joystick), such as by which the user can provide input to the computer.

In various implementations, the system may communicate using suitable communication methods, equipment, and techniques. For example, the system may communicate with compatible devices (e.g., devices capable of transferring data to and/or from the system) using point-to-point communication in which a message is transported directly from the source to the receiver over a dedicated physical link (e.g., fiber optic link, point-to-point wiring, daisy-chain). The components of the system may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, the computers and networks forming the Internet, or some combination thereof. Other implementations may transport messages by broadcasting to all or substantially all devices that are coupled together by a communication network, for example, by using omni-directional radio frequency (RF) signals. Still other implementations may transport messages characterized by high directivity, such as RF signals transmitted using directional (i.e., narrow beam) antennas or infrared signals that may optionally be used with focusing optics. Still other implementations are possible using appropriate interfaces and protocols such as, by way of example and not intended to be limiting, USB 2.0, Firewire, ATA/IDE, RS-232, RS-422, RS-485, 802.11 a/b/g, Wi-Fi, Ethernet, IrDA, FDDI (fiber distributed data interface), token-ring networks, multiplexing techniques based on frequency, time, or code division, or some combination thereof. Some implementations may optionally incorporate features such as error checking and correction (ECC) for data integrity, or security measures, such as encryption (e.g., WEP) and password protection.

Various examples of modules may be implemented using circuitry, including various electronic hardware. By way of example and not limitation, the hardware may include transistors, resistors, capacitors, switches, integrated circuits, other modules, or some combination thereof. In various examples, the modules may include analog logic, digital logic, discrete components, traces and/or memory circuits fabricated on a silicon substrate including various integrated circuits (e.g., FPGAs, ASICs), or some combination thereof. In some embodiments, the module(s) may involve execution of preprogrammed instructions, software executed by a processor, or some combination thereof. For example, various modules may involve both hardware and software.

In an illustrative aspect, an object detection system may include an antenna module configured to emit a radar beam. For example, the object detection system may include a single unitary lens configured to receive the radar beam at an internal surface and emit a shaped beam at an external surface. For example, the object detection system may include a housing configured to couple the single lens to the antenna module at a predetermined distance from the internal surface to an emitting surface of the radar antenna such that the predetermined distance may include a multiple of a half wavelength of the radar beam in air. For example, the internal surface may include a first radius of curvature in a first direction and a second radius of curvature in a second direction. For example, the external surface may include a third radius of curvature in a third direction and a fourth radius of curvature in a fourth direction.

For example, the first direction and the second direction may be orthogonal to each other. For example, the third direction and the fourth direction may be orthogonal to each other. For example, the first radius of curvature, the second radius of curvature, the third radius of curvature, and the fourth radius of curvature each may include a corresponding degree of curvature independent of each other. For example, when the radar beam may be traversing through the single lens, the shaped radar beam may be shaped in four degrees of freedom by the single lens.

For example, the single lens may include a thickness distribution profile defined by the first radius of curvature, the second radius of curvature, the third radius of curvature. For example, the fourth radius of curvature, such that a focusing power of the single lens may be independently configurable in each of the orthogonal directions.

For example, the first direction and the second direction. For example, the third direction and the fourth direction may be rotated relative to an emission axis of the radar beam. For example, the first direction and the third direction may be parallel to each another and the second direction and the fourth directions may be parallel to each other. For example, at least one of the internal surface and the external surface may include at least a fifth radius of curvature in a fifth direction.

For example, the lens module may be releasably coupled to the housing. For example, the lens module may be replaceable. For example, the lens module may include a ledge, the ledge may be configured to frictionally coupled to a receiving surface the housing. For example, the radar beam may be shaped such that a field-of-view of the shaped radar beam may include asymmetric field of view angles.

In an illustrative aspect, an object detection system may include an antenna module configured to emit a radar beam. For example, a lens module configured to receive the radar beam at an internal surface and emit a shaped beam at an external surface. For example, the lens module may be coupled to the radar antenna at a predetermined distance from the internal surface to an emitting surface of the radar antenna. For example, the predetermined distance may include a multiple of a half wavelength of the radar beam in air. For example, the internal surface may include a first radius of curvature in a first direction and a second radius of curvature in a second direction. For example, the external surface may include a third radius of curvature in a third direction and a fourth radius of curvature in a fourth direction. For example, the first direction and the second direction may be orthogonal to each other. For example, the third direction and the fourth direction may be orthogonal to each other.

For example, the first radius of curvature, the second radius of curvature, the third radius of curvature, and the fourth radius of curvature each may include a corresponding degree of curvature independent of each other. For example, when the radar beam may be traversing through the lens module, the radar beam may be shaped in four degrees of freedom by the lens module.

For example, the lens module may include a thickness distribution profile defined by the first radius of curvature, the second radius of curvature, the third radius of curvature. For example, the fourth radius of curvature, such that a focusing power of the lens module may be independently configurable in each of the orthogonal directions.

For example, the lens module may include a single lens, the single lens may include four independently configurable radius of curvatures, the internal surface may include two of the independently configurable radius of curvatures in orthogonal directions. For example, the external surface may include two of the independently configurable radius of curvatures in orthogonal directions.

For example, the first direction and the second direction, the third direction, and the fourth direction may be rotated relative to an emission axis of the radar beam. For example, the first direction and the third direction may be parallel to each another. For example, the second direction and the fourth directions may be parallel to each other.

For example, the internal surface or the external surface may include a fifth radius of curvature in a fifth direction. For example, the object detection system may include a housing configured to couple the antenna module to the lens module such that a distance between the internal surface to the emitting surface may include a multiple of a half wavelength of the radar beam in air.

For example, the lens module may be releasably coupled to the housing. For example, the lens module may be replaceable. For example, the lens module may include a ledge. For example, the ledge may be configured to frictionally coupled to a receiving surface the housing. For example, the radar beam may be shaped such that a field-of-view of the shaped radar beam may include asymmetric field of view angles.

In an illustrative aspect, a beam shaping lens configuration method may include receive a target two dimensional field-of-view (715). For example, the beam shaping lens configuration method may provide a single lens including a refraction profile based on a type of material of the single lens. For example, the single lens may be configured to receive a radar beam at an internal surface and emit a shaped beam at an external surface. For example, the internal surface may include a first radius of curvature in a first direction and a second radius of curvature in a second direction. For example, the external surface may include a third radius of curvature in a third direction and a fourth radius of curvature in a fourth direction. For example, the first direction and the second direction may be orthogonal to each other. For example, the third direction and the fourth direction may be orthogonal to each other.

For example, the beam shaping lens configuration method may retrieve a characteristic profile of the radar beam, the characteristic profile may include a field of view of the radar beam and a power intensity of the radar beam. For example, the beam shaping lens configuration method may determine a distance between the internal surface and an emission source of the radar beam, the distance may be a multiple of a half wavelength of the radar beam.

For example, the beam shaping lens configuration method may generate a thickness distribution profile of the single lens as a function of the target two dimensional field-of-view of and the determined distance, such that the radar beam may be shaped in four degrees of freedom by the single lens to match the target field-of-view, the thickness distribution profile may be defined by the first radius of curvature, the second radius of curvature, the third radius of curvature, and the fourth radius of curvature. For example, a focusing power of the single lens may be independently configurable in each of the first direction, the second direction, the third direction, and the fourth direction. For example, the radar beam may be shaped in four degrees of freedom in each of the directions by the single lens. For example, the beam shaping lens configuration method may include test the single lens using an optical simulation tool such that a resulting performance of the single lens may be predicted.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

1. An object detection system comprising:
an antenna module (125) configured to emit a radar beam;
a single unitary lens (130) configured to receive the radar beam at an internal surface (170) and emit a shaped beam at an external surface (175); and,
a housing (160) configured to couple the single lens to the antenna module at a predetermined distance (165) from the internal surface to an emitting surface of the antenna module such that the predetermined distance comprises a multiple of a half wavelength of the radar beam in air wherein:
the internal surface comprises a first radius of curvature in a first direction and a second radius of curvature in a second direction, and the external surface comprises a third radius of curvature in a third direction and a fourth radius of curvature in a fourth direction,
the first direction and the second direction are orthogonal to each other, and the third direction and the fourth direction are orthogonal to each other, and
the first radius of curvature, the second radius of curvature, the third radius of curvature, and the fourth radius of curvature each comprises a corresponding degree of curvature independent of each other such that, when the radar beam is traversing through the single lens, the shaped radar beam is shaped in four degrees of freedom by the single lens.

2. The object detection system of claim 1, the single lens comprises a thickness distribution profile defined by the first radius of curvature, the second radius of curvature, the third radius of curvature, and the fourth radius of curvature, such that a focusing power of the single lens is independently configurable in each of the orthogonal directions.

3. The object detection system of claim 1, wherein the first direction and the second direction, and the third direction and the fourth direction are rotatable relative to an emission axis of the radar beam.

4. The object detection system of claim 1, wherein the first direction and the third direction are parallel to each another and the second direction and the fourth directions are parallel to each other.

5. The object detection system of claim 1, wherein at least one of the internal surface and the external surface comprises at least a fifth radius of curvature in a fifth direction.

6. The object detection system of claim 1, wherein the single unitary lens is releasably coupled to the housing such that, the lens module is replaceable.

7. The object detection system of claim 1, wherein the single unitary lens further comprising a ledge, wherein the ledge is configured to frictionally coupled to a receiving surface the housing.

8. The object detection system of claim 1, wherein the radar beam is shaped such that a field-of-view of the shaped radar beam comprises asymmetric field of view angles.

9. An object detection system comprising:
an antenna module (125) configured to emit a radar beam; and,
a lens module (130) configured to receive the radar beam at an internal surface (170) and emit a shaped beam at an external surface (175), wherein:
the lens module is coupled to the antenna module at a predetermined distance from the internal surface to an emitting surface of the radar antenna, wherein the predetermined distance (165) comprises a multiple of a half wavelength of the radar beam in air,
the internal surface comprises a first radius of curvature in a first direction and a second radius of curvature in a second direction, and the external surface comprises a third radius of curvature in a third direction and a fourth radius of curvature in a fourth direction wherein the first direction and the second direction are orthogonal to each other, and the third direction and the fourth direction are orthogonal to each other, and
the first radius of curvature, the second radius of curvature, the third radius of curvature, and the fourth radius of curvature each comprises a corresponding degree of curvature independent of each other such that, when the radar beam is traversing through the lens module, the radar beam is shaped in four degrees of freedom by the lens module.

10. The object detection system of claim 9, the lens module comprises a thickness distribution profile defined by the first radius of curvature, the second radius of curvature, the third radius of curvature, and the fourth radius of curvature, such that a focusing power of the lens module is independently configurable in each of the orthogonal directions.

11. The object detection system of claim 9, wherein the lens module comprises a single lens, wherein the single lens comprises four independently configurable radius of curvatures, wherein the internal surface comprises two of the independently configurable radius of curvatures in orthogonal directions, and the external surface comprises two of the independently configurable radius of curvatures in orthogonal directions.

12. The object detection system of claim 9, wherein the first direction and the second direction, and the third direction and the fourth direction are rotatable relative to an emission axis of the radar beam.

13. The object detection system of claim 9, wherein the first direction and the third direction are parallel to each another, and the second direction and the fourth directions are parallel to each other.

14. The object detection system of claim 9, wherein the internal surface or the external surface comprises a fifth radius of curvature in a fifth direction.

15. The object detection system of claim 9, further comprising a housing configured to couple the antenna module to the lens module such that a distance between the internal surface to the emitting surface comprises a multiple of a half wavelength of the radar beam in air.

16. The object detection system of claim 15, wherein the lens module is releasably coupled to the housing such that, the lens module is replaceable.

17. The object detection system of claim 15, wherein the lens module further comprises a ledge, wherein the ledge is configured to frictionally coupled to a receiving surface the housing.

18. The object detection system of claim 9, wherein the radar beam is shaped such that a field-of-view of the shaped radar beam comprises asymmetric field of view angles.

19. A beam shaping lens configuration method comprising:
receive a target two dimensional field-of-view (715);
provide a single lens comprising a refraction profile based on a type of material of the single lens, wherein the single lens is configured to receive a radar beam at an internal surface and emit a shaped beam at an external surface (710), and wherein the internal surface comprises a first radius of curvature in a first direction and a second radius of curvature in a second direction, and the external surface comprises a third radius of curvature in a third direction and a fourth radius of curvature in a fourth direction, wherein the first direction and the second direction are orthogonal to each other, and the third direction and the fourth direction are orthogonal to each other;
retrieve a characteristic profile of the radar beam (705), wherein the characteristic profile comprises a field of view of the radar beam and a power intensity of the radar beam;
determine a distance between the internal surface and an emission source of the radar beam (720), wherein the distance is a multiple of a half wavelength of the radar beam; and,
generate a thickness distribution profile (735) of the single lens as a function of the target two dimensional field-of-view of and the determined distance, such that the radar beam is shaped in four degrees of freedom by the single lens to match the target field-of-view, wherein the thickness distribution profile is defined by the first radius of curvature, the second radius of curvature, the third radius of curvature, and the fourth radius of curvature, such that,
a focusing power of the single lens is independently configurable in each of the first direction, the second direction, the third direction, and the fourth
